(19) United States
(12) Patent Application Publication
(10) Pub. No.: US 2007/0002555 A1
(43) Pub. Date: Jan. 4, 2007

(54) Backlight module having bumpy reflective plate

(75) Inventor: Shao-Han Chang, MiaoLi (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/478,703

(22) Filed: Jun. 30, 2006

(30) Foreign Application Priority Data
Jul. 1, 2005 (TW) 94122313

(51) Int. Cl. G09F 13/04

(52) U.S. Cl. 362/97; 362/241; 362/260

(57) ABSTRACT

An exemplary backlight module (2) includes a plurality of light sources (30), a diffusion sheet (20), and a reflective plate (40). The light sources are disposed between the diffusion sheet and the reflective plate, and the reflective plate includes a plurality of elongate bumps (41) thereon, integrally formed therewith. The bumps face toward the diffusion sheet, and each of the bumps is located generally midway between two corresponding adjacent of the light sources. Each bump is located midway between two adjacent light sources for concentrating and guiding reflected light beams toward a corresponding area of the diffusion sheet above the bump. Accordingly, a light intensity distribution in the area of the diffusion sheet above the bump is closer to the same as a light intensity distribution in each of areas of the diffusion sheet above the two adjacent light sources.

### FIELD OF THE INVENTION

The present invention relates to backlight modules such as those used in liquid crystal displays (LCDs), and particularly to a backlight module with a plurality of light sources and a corresponding reflective plate.

### BACKGROUND

A typical LCD device includes a liquid crystal display panel, and a backlight module mounted under the liquid crystal display panel for supplying light beams thereto. The backlight module is generally classified into one of two types—a direct type or an edge type—according to the position in which a light source is installed in a backlight unit of the backlight module.

In the case of a direct type backlight module, the light source may be one or more elongate lamps or a plurality of light emitting diodes (LEDs). A light spreading plate and a light reflection plate are installed at top and bottom sides of the light source respectively. The light spreading plate is located directly under the liquid crystal display panel. Accordingly, some light beams are substantially directly output from the light source to the liquid crystal display panel positioned above the light spreading plate, and other light beams reflected from the light reflection plate are then substantially directly output to the liquid crystal display panel.

FIG. 4 is a schematic side view of a conventional backlight module. The backlight module 1 includes a diffusion sheet 11, a plurality of lamps 12, and a reflective plate 13. The diffusion sheet 11 and the reflective plate 13 are thin and rectangular, and each of the lamps 12 is elongate. The lamps 12 are disposed between the diffusion sheet 11 and the reflective plate 13.

Also referring to FIG. 5, this shows reflective optical paths in the backlight module 1. Some of light beams (not shown) emitted by the lamps 12 directly transmit to the diffusion sheet 11. Other light beams emitted by the lamps 12 transmit to the diffusion sheet 11 after being reflected by the reflective plate 13. All the light beams then pass through the diffusion sheet 11 to illuminate an associated liquid crystal display panel.

However, the backlight module 1 has the following disadvantage. A majority of the light beams are transmitted to areas of the diffusion sheet 11 directly above the lamps 12, whereas a smaller quantity of the light beams are transmitted to areas 14 of the diffusion sheet 11 that are generally between each two adjacent lamps 12. Thus light intensity distribution in the areas directly above the lamps 12 is greater than light intensity distribution in the areas 14 generally between the lamps 12. This uneven light intensity distribution at the diffusion sheet 11 typically prevents the backlight module 1 from attaining a uniform light intensity distribution.

Accordingly, what is needed is a backlight module that can overcome the above-described deficiencies.

### SUMMARY

An exemplary backlight module includes a plurality of light sources, a diffusion sheet, and a reflective plate. The light sources are disposed between the diffusion sheet and the reflective plate, and the reflective plate includes a plurality of elongate bumps thereon, integrally formed therewith. The bumps face toward the diffusion sheet, and each of the bumps is located generally midway between two corresponding adjacent of the light sources.

Other advantages and novel features will become more apparent from the following detailed description when taken in conjunction with the accompanying drawings. In the drawings, all the views are schematic.

### BRIEF DESCRIPTION OF THE DRAWINGS

FIG. 1 is a side view of a backlight module according to an exemplary embodiment of the present invention.

FIG. 2 is an isometric view of a reflective plate of the backlight module of FIG. 1.

FIG. 3 is an enlarged view of part of the backlight module of FIG. 1, showing reflective optical paths thereof.

FIG. 4 is a side view of a conventional backlight module.

FIG. 5 is an enlarged view of part of the backlight module of FIG. 4, showing reflective optical paths thereof.

### DETAILED DESCRIPTION OF PREFERRED EMBODIMENTS

Reference will now be made to the drawings to describe the present invention in detail.

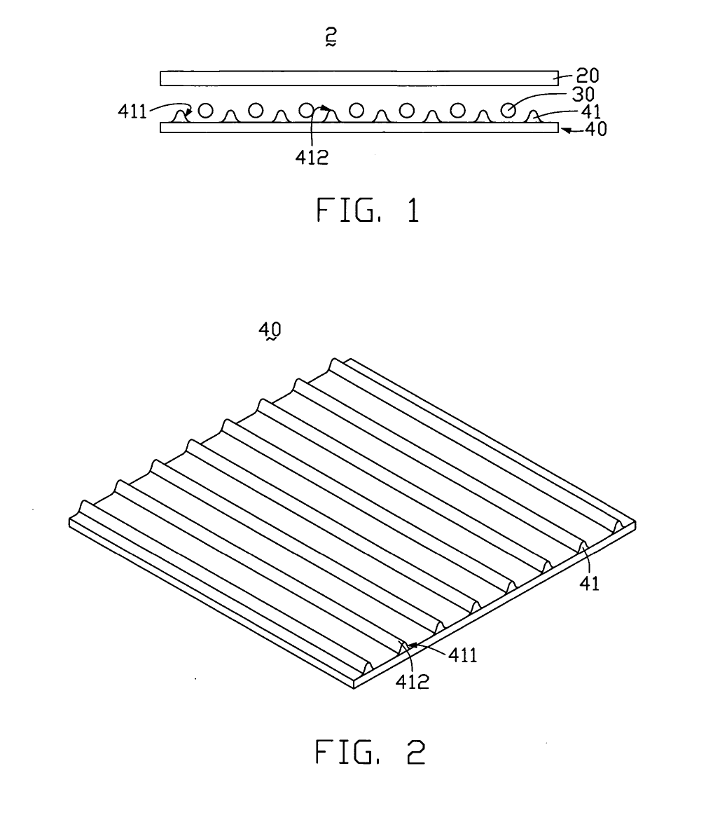

Referring to FIG. 1, this is a schematic, side view of a backlight module according to an exemplary embodiment of the present invention. The backlight module 2 includes a diffusion sheet 20, a plurality of light sources 30, and a reflective plate 40. The light sources 30 are typically elongate cold cathode fluorescent lamps (CCFLs) or the like, and are arranged between the diffusion sheet 20 and the reflective plate 40.

Also referring to FIG. 2, the reflective plate 40 is made of material having high reflectivity, such as aluminum, aluminum alloy, or a like material. The reflective plate 40 includes a plurality of elongate bumps 41. The bumps 41 are integrally formed with the reflective plate 40, and face toward the diffusion sheet 20. The bumps 41 are parallel to and spaced apart from each other, and are parallel to a side of the reflective plate 40. Each of the bumps 41 defines a top portion 412, and two reflective curved surfaces 411 extending from respective opposite sides of the top portion 412 down to a flat main body of the reflective plate 40.

In assembly, each of the light sources 30 is arranged generally midway between two corresponding adjacent bumps 41. That is, the light sources 30 and the bumps 41 are arranged alternately from one side of the reflective plate 40 to an opposite side of the reflective plate 40. In the illustrated embodiment, central axes of the light sources 30 and vertexes of the top portions 412 of the bumps 41 all lie substantially in a same plane.

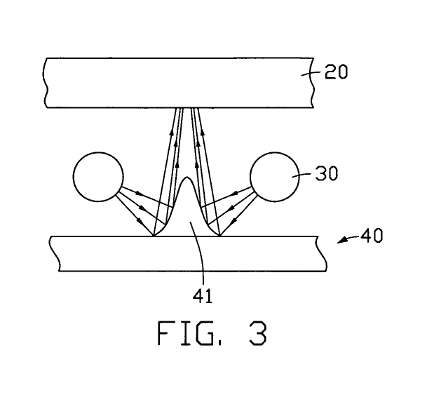

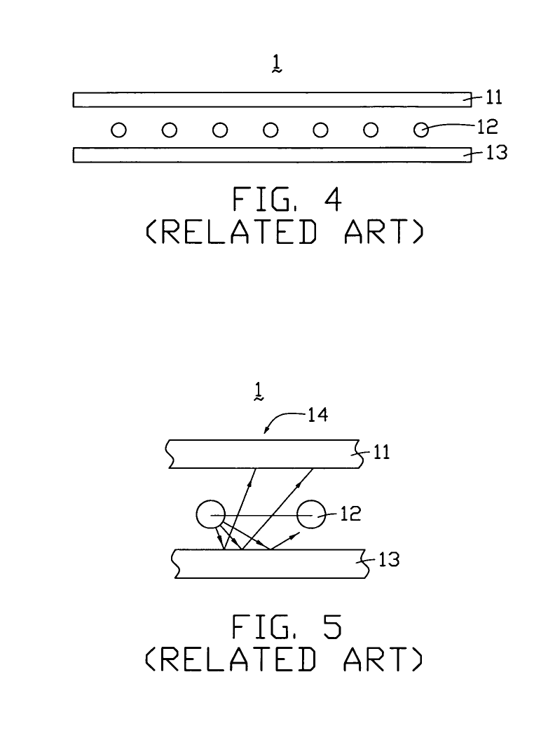

Also referring to FIG. 3, this shows reflective optical paths in the backlight module 2. Each bump 41 is located midway between two adjacent light sources 30. Therefore the reflective curved surfaces 411 of the bump 41 reflect light beams such that the light beams are concentrated and guided toward a corresponding area of the diffusion sheet 20 above the bump 41. Accordingly, a light intensity distribution in the area of the diffusion sheet 20 above the bump 41 is closer to, or similar to, or the same as a light intensity distribution in each of areas of the diffusion sheet 20 above the two adjacent light sources 30. That is, the light beams that reach all areas of the diffusion sheet 20 enable the diffusion sheet 20 to have highly uniform light intensity overall.

It is to be understood, however, that even though numerous characteristics and advantages of the present embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A backlight module, comprising:
a plurality of light sources;
a diffusion sheet; and
a reflective plate;
wherein the light sources are disposed between the diffusion sheet and the reflective plate, the reflective plate comprises a plurality of elongate bumps thereon integrally formed therewith, the bumps face toward the diffusion sheet, and each of the bumps is located generally midway between two corresponding adjacent of the light sources.

2. The backlight module as claimed in claim 1, wherein the light sources are lamps.

3. The backlight module as claimed in claim 2, wherein the lamps are cold cathode fluorescent lamps.

4. The backlight module as claimed in claim 1, wherein central axes of the light sources and vertexes of the bumps lie substantially in a same plane.

5. The backlight module as claimed in claim 1, wherein the bumps are parallel to each other and spaced apart from each other.

6. The backlight module as claimed in claim 5, wherein each of the bumps defines a top portion, and two reflective curved surfaces extending from respective opposite sides of the top portion down to a flat main body of the reflective plate.

7. The backlight module as claimed in claim 6, wherein the reflective curved surfaces of each of the bumps are configured to reflect light beams such that the light beams are concentrated and guided toward a corresponding area of the diffusion sheet above the bump.

8. The backlight module as claimed in claim 1, wherein the reflective plate including the bumps is made of material having high reflectivity.

9. The backlight module as claimed in claim 8, wherein the high reflectivity material is aluminum or aluminum alloy.
